(19) United States
(12) Patent Application Publication
(10) Pub. No.: US 2017/0306691 A1
(43) Pub. Date: Oct. 26, 2017

(54) DOOR STRUCTURE WITH THERMAL BRIDGE BREAKS

(71) Applicant: RODRIGO MEDINA SOTELO, MITRAS (MX)

(72) Inventor: RODRIGO MEDINA SOTELO, MITRAS (MX)

(21) Appl. No.: 15/228,985

(22) Filed: Aug. 4, 2016

(30) Foreign Application Priority Data
Apr. 26, 2016 (MX) MX/U/2016/000174

(51) Int. Cl. E06B 3/70

(52) U.S. Cl. CPC E06B 3/7015; E06B 3/70; E06B 2003/7076; E06B 2003/7023

(57) ABSTRACT

The invention refers to a door structure with thermal bridge brake defined by a door element mounted through hinges on a metal frame; characterized by such door element being defined by an inner metal panel and an outer metal panel bent in the shape of an idler; with celeron hearths provided on the perimeter as thermal bridge break element, defining a middle cavity filled with expanded polyurethane or other materials with isolating properties. Such inner and outer metal panels are joined on the perimeter, through welding points. The metal frame consists of a hollow outer metal frame and a hollow inner metal frame filled with expanded polyurethane or other materials with similar isolating properties, with a celeron hearth between them as a thermal bridge break element, joined by welding points in specific areas.

This application claims the benefit of Mexico application No. MX/u/2016/000174 filed on Apr. 26, 2016. The content of this document and the entire disclosure of publications, patents, and patent documents mentioned herein are incorporated by reference.

### FIELD OF INVENTION

This innovation belongs to the forge field; generally related to metal products and items, and in this case, it is specifically related to a door structure with thermal bridge breaks.

### INVENTION BACKGROUND

Currently, several types of metal doors are in the market, which solve many needs of the customers regarding design and safety. However, doors have a design problem, as when the doors are installed in places with very cold weather, the inner area of the door is hotter than the outer area, which leads to condensation.

A metal door may be described in many ways in relation to its composition, such as single or double. Their design can vary, they could be square, with an arch, or a semicircular arch door. Doors can also have fixed elements (safety elements, decorations) either on one side or both sides or at the top pf the door, or it could be a one-piece element, or a mix of all of the above.

By searching information on the status of the technique, U.S. Pat. No. 8,516,756 from Jonathan D. Thierlmann of Oct. 13, 2009 was found, which presents a door panel including a frame, a laminated core, several thermally isolating connectors and an outer layer. The frame outlines a section of the panel outer periphery and it has a lower section and an outer section, which are positioned on the top and outer parts, adjacent to the panel. The laminated core is places between the inner and outer section of the frame. The thermally isolating connectors connect the inner and outer sections to the core. The outer layer covers the frame. The core is a thermal barrier between the inner and outer sections. The inner and outer sections are formed from a thermally isolating material. The core includes an inner layer built with a thermally conductive material, and two external layers made of steel. The thermally isolating connectors include a thermally isolating jacket and a fixation element placed inside the jacket.

U.S. Pat. No. 6,226,958 from Kenneth J. West, presented on Aug. 2, 1999 was also found, which includes compression-molded, coated, pigmented doors, manufactured through a compression-molding process, which contain an unsaturated co-curable monomer, a low-profile additive and a micro-holes reducing thermoplastic polymer to have an even sustainability while the low-expansion linear thermal coefficient is maintained. Such door coatings are appropriate for the preparation of textured wood for exterior isolated doors that have a minimal thermal deflection when exposed to interior/exterior temperature variation.

Nevertheless, none of the door structures offers the functional and structural advantages of the thermal bridge break in the invention herein. Thus, the door structure with thermal bridge break offers the chance to prevent condensation on the inner part of doors in places with very cold weather.

### INVENTION OBJECTIVES

The main objective of the invention herein is to make an innovative metal door structure available, with a thermal bridge break that prevents condensation on the inner face, which is hotter than the outer face, when the doors are installed in places with cold weather.

Another objective of the invention is to make such metal door structure with thermal bridge break available, which is also resistant, with an appealing appearance.

Another objective of the invention is to make such metal door structure with thermal bridge break available, also offering safety, a robust, resistant and long-lasting structure.

Another objective of the invention is to make such metal door structure with thermal bridge break available, which is also easily assembled, easily installed, with no equipment, tools and specialized work force required for its installation.

All these qualities and objectives will become evident when making a general and detailed description of this invention, supported on the illustrated modalities.

### SHORT DESCRIPTION OF THE INVENTION

In general, the door structure with thermal bridge break, according to the invention herein, in its preferred modality, is defined by a door element mounted through hinged items on a metal frame; where such door element is defined by an inner metal panel bent, in the shape of an idler and an outer metal panel bent in the shape of an idler or an outer panel with a perforated hearth; with celeron hearths on the perimeter as a thermal bridge break element, defining a middle cavity filled with expanded polyurethane foam, or other similar materials with isolating properties; and which such inner metal panel and such outer metal panel or the outer panel with perforated hearth, joined on the perimeter, through welding points.

In one of the invention modalities, at least the outer face of the outer metal panel may or may not have protecting, decorative ironwork.

In one of the preferred modalities of the invention, where such door element is formed by inner and outer panels bent in the shape of an idler of such door element define a rectangular frame whose bends establish an outer and inner perimeter edge where the celeron hearths with notches are provided on the outer edges as a thermal bridge break element, where every notch defines the space to receive welding points to join such inner and outer metal panels. It may or may not have at least one or more transversal bent panels in the shape of an idler, fixed to the lower area of every rectangular frame of each inner and outer metal panels, making them stay parallel to each other, defining an upper and lower opening, whose bends establish edges where celeron hearths are provided as a thermal bridge break element. Inner and outer steel plates are fixed internally and externally to such lower opening and a celeron plate is provided between them, as a thermal bridge break element.

The cavities defined between the inner and outer metal panels bent in the shape of an idler defining the rectangular frames; as well as the cavities defined between the inner and outer steel plates and the cavities defined between the bent transversal panels in the shape of an idler are filled with expanded polyurethane or other materials with similar isolating properties.

Such upper opening is covered with either translucent panels made of glass, acrylic or other translucent materials with similar properties or with non-translucent solid panels, arranged as two parallel panels detached from each other to define an isolating cavity, mounted on tubular moldings and sealing gaskets whose hollows can be filled with polyurethane or other materials with similar properties as an isolating element, and using sealing gaskets and; alternatively, protecting and decorative ironwork fixed to the outer part of the door element, preferably fixed to the fixation molding's of the translucent panels on the upper opening.

In other modalities of the invention, the upper opening is covered, just like the lower opening.

In the preferred modality of the invention, such hollow exterior metal frame and such hollow inner metal frame are co-linearly fixed, with the celeron hearth provided with notches or lateral perforations on the adjacent faces, allowing a free external reduced area on every notch or perforation to receive the welding points between both frames. Such hollow outer metal frame is defined by a metal frame bent in the shape of an idler, with the face where the bends are generated defining an opening. Such face is fixed to such hollow inner metal frame, which is defined by a rectangular tubular profile, where both inner and outer hollow metal frames are filled with expanded polyurethane or other materials with similar isolating properties.

A tubular vertical stop element is fixed on the join area between such hollow outer metal frame and such hollow inner metal frame on the adjacent face where the door element is fixed with hinges to such metal frame with a gasket between them to seal the door and prevent the air intake.

In the modality where such door element consists of an inner metal panel bent in the shape of an idler, defining an inner rectangular frame and a perforated hearth outer panel defining an outer rectangular frame; the celeron hearth (also defined as a frame) provided between them as a thermal bridge break element, comprises several holes distributed in a certain pattern in the same position as the perforations of such perforated hearth outer panel, adapted to receive the welding points that will join such inner metallic panel bent in the shape of an idler and such outer panel with a perforated hearth.

In this modality, two transversal panels bent in the shape of an idler may be included, fixed to the inner rectangular frames, as well as two transversal panels with perforated hearths fixed to the outer rectangular frames, in parallel, with celeron hearths with perforations that match the ones on such transversal panels with perforated hearths, to receive penetrating welding points and defining three openings; a lower, upper and middle opening.

Where the middle opening area on the inner edge of the door, opposed to the edge fixed to the door frame, includes a vertical panel with a perforated hearth which is fixed on both transversal panels with perforated hearth joined to the outer rectangular frame and a vertical frame in the shape of an idler, fixed to the inner rectangular frame; with celeron hearths with perforations that match the perforations of such vertical panel with perforated hearth to receive the fixation penetrating welding points.

As described above, the internal hollows generated between such outer and inner rectangular frames of the door element are filled with expanded polyurethane or other materials with similar isolating properties.

In this modality, where such door element is comprised by an inner metal panel bent in the shape of an idler that defines an inner rectangular frame and an outer panel with perforated hearth defining a rectangular outer frame; such outer panel with perforated hearth defining an outer rectangular frame is wider than such inner metal frame bent in the shape of an idler defining an inner rectangular frame, in such a way that a protruding flange is generated towards the inner face and along with a vertical tubular element fixed to the inner face of such inner metal panel bent in the shape of an idler defining an inner rectangular frame, they define a perimeter channel that is used as a fixation element, along with gaskets, to receive translucent panels made of glass, acrylic or other translucent materials with similar properties or non-translucent solid panels covering the upper, lower and middle openings in parallel, detached from each other, one on the outer area and another on the inner area, detached from each other to define an isolating cavity.

A tubular vertical stop element is fixed to the join area between such hollow outer metal frame and such hollow inner metal frame on the adjacent face where the door element is fixed with hinges to such metal frame with a gasket between them to seal the door and prevent the air intake.

The welding points are applied according to the door structural calculation to determine the distance and length of the welding points, as the celeron hearth is a non-metallic material, notches or perforations will be performed, as necessary, so the welding has the appropriate penetration between panels and not to damage the resistance thereof. This procedure is performed on both sides of the panels and on the upper, side, middle and lower areas of the door.

Such celeron hearths define a highly thermal material, preferably, celeron G-10, as it can stand high and low temperature ranges, which makes it a great material to use when welding, even when the welding points are very close to the material. Likewise, it has a low moisture absorption, which makes it an excellent material to use to manufacture metal doors as, due to its resistance to chemicals, it can be painted on with any type of paint, even electrostatic paint.

To better understand the invention characteristics, the following illustrative, but not limiting, drawings are included to this description, which are fully described below the preferred modality.

### SHORT DESCRIPTION OF FIGURES

FIG. 1 shows a front view of the door with a thermal bridge break, according to the preferred modality of the invention.

FIG. 1a is a cross-section of line A-A′ of FIG. 1, from the top of the door structure with a thermal bridge break in its preferred modality.

FIG. 2 shows an exploded cross-section from the top of the door structure with thermal bridge break in its preferred modality.

FIG. 2a shows a cross-section from the top of the door structure with thermal bridge break in its preferred modality.

FIG. 3 shows an exploded section of the door with a thermal bridge break, according to the preferred modality of the invention.

FIG. 4 shows a conventional view of the door with a thermal bridge break, according to the preferred modality of the invention.

FIG. 4a shows a lower area cut of the door with thermal bridge break, according to the preferred modality of the invention, showing the elements that form this section.

FIG. 5 shows a rear view of the door with a thermal bridge break, according to the preferred modality of the invention.

FIG. 6 shows a rear view of the door with a thermal bridge break, according to the preferred modality of the invention.

FIG. 7 shows an exploded section of other modalities of the door structure with a thermal bridge break, according to the preferred modality of the invention.

FIGS. 8 and 9 show a front inner view and an outer view of the door of the modality shown in FIG. 7.

FIG. 10 shows a cross-section of line X-X′ of FIG. 8, from the top of the door structure with a thermal bridge break in the modality shown in FIGS. 7 to 9.

FIG. 11 shows a cross-section from the top of the door structure with thermal bridge break in the modality shown in FIGS. 7 to 10.

FIG. 12 shows an exploded cross-section from the top of the door structure with thermal bridge break in the modality shown in FIGS. 7 to 11.

To better understand the invention, a detailed description of some of its modalities is found below, shown through the illustrative, but not limiting drawings attached to the description herein.

### DETAILED DESCRIPTION OF THE INVENTION

The characteristic details of the door structure with thermal bridge break are clearly shown through the following description and the illustrative drawings attached, with the same reference signs to point out the same parts.

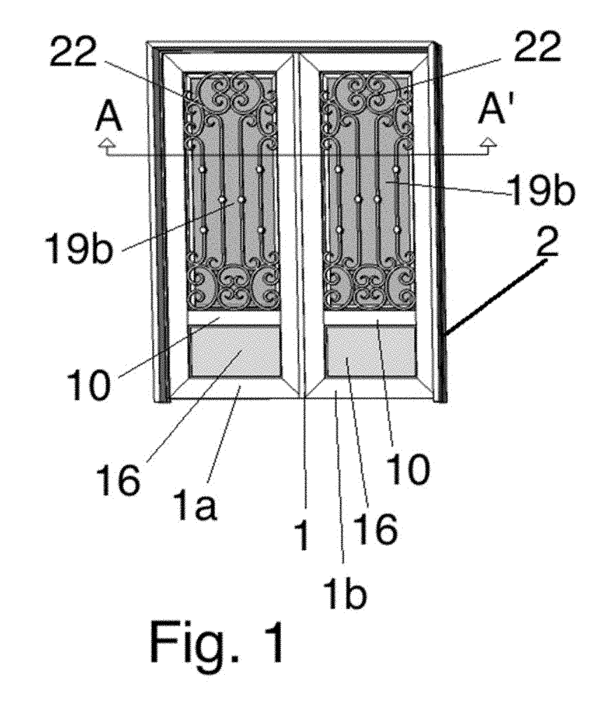

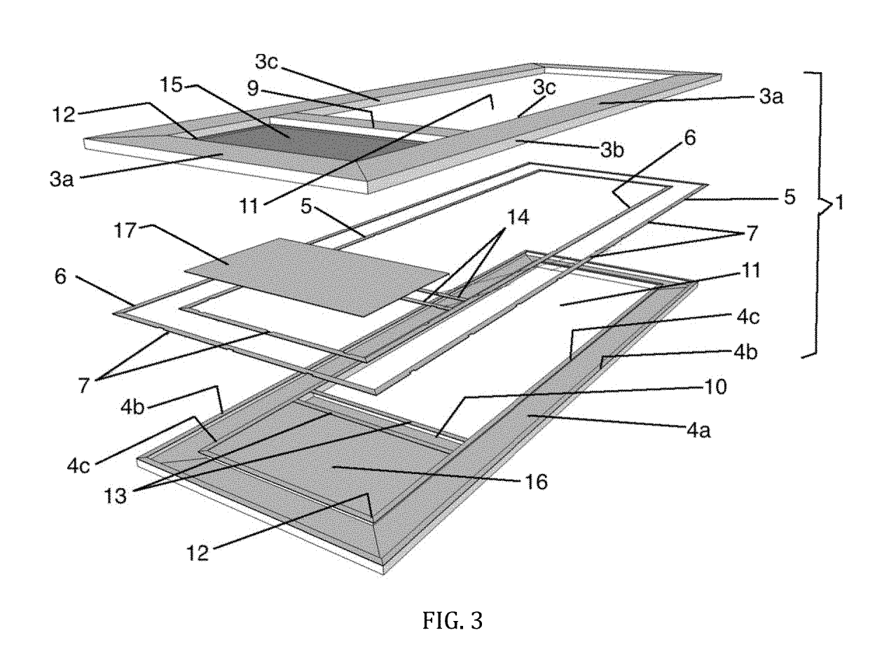

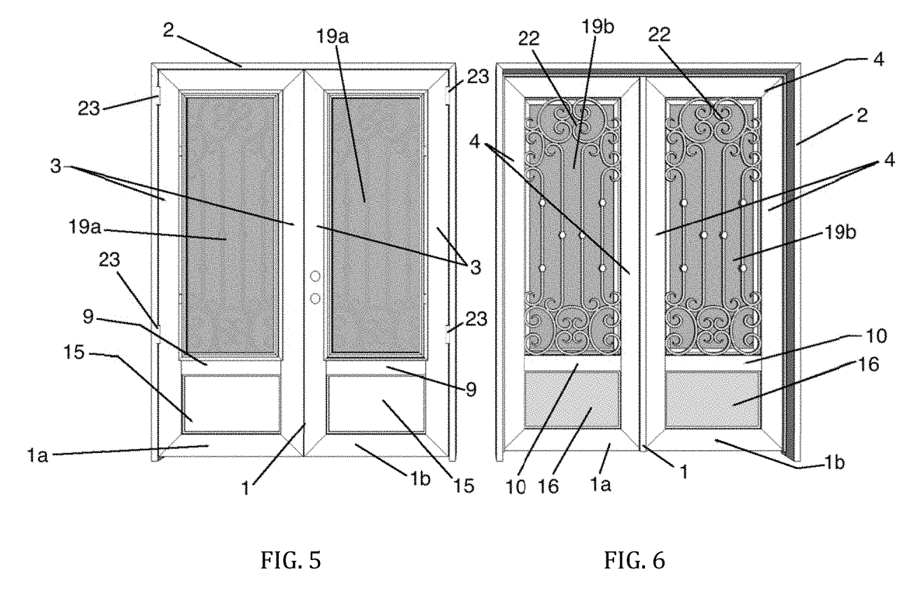

In relation to FIGS. 1 to 6, the door structure with thermal bridge break, according to this invention is defined by a door element (1) mounted with hinges (23, see FIG. 5) in a metal frame (2); where such door element (1) is defined by an inner metal frame (3) and an outer metal panel (4) bent in the shape of an idler, which define a rectangular frame (3a, 4a, see FIG. 3) whose bends establish an outer perimeter edge (3b, 4b) and an inner perimeter edge (3c, 4c) where celeron hearths are provided (5, 6) with notches (7) as a thermal bridge break element, and where every notch (7) defines a space to receive welding points (8) to join such inner (3) and outer (4) metal panels. At least one transversal panel (9, 10, see FIG. 3) bent in the shape of an idler, fixed to the lower area of every rectangular frame of each inner (3) and outer (4) metal panels, which stay parallel to each other, defining an upper opening (11) and a lower opening (12), whose bends establish (13) edges where celeron hearths are provided (14) as a thermal bridge break element; an inner steel plate (15) and an outer steel plate (16) are fixed, internally and externally, to such lower opening (12) and a celeron plate (17) is provided between them, as a thermal bridge break element.

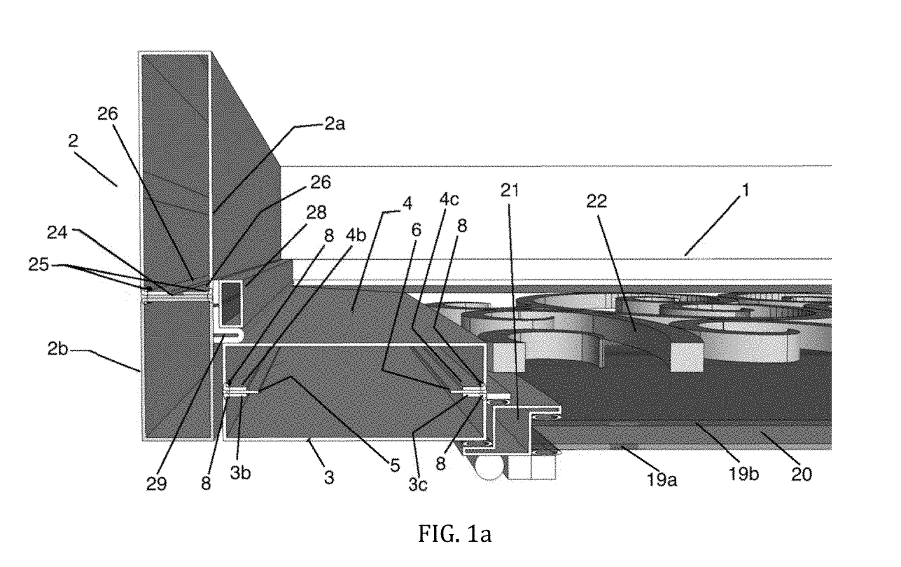

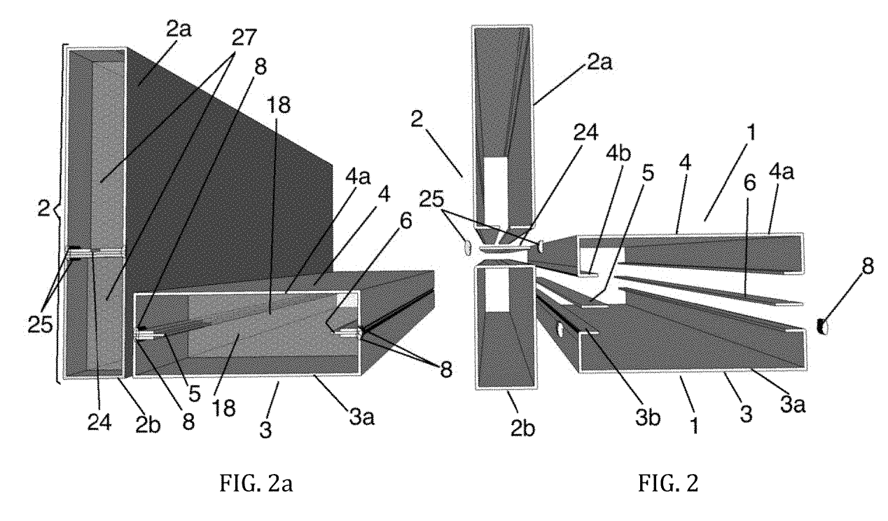

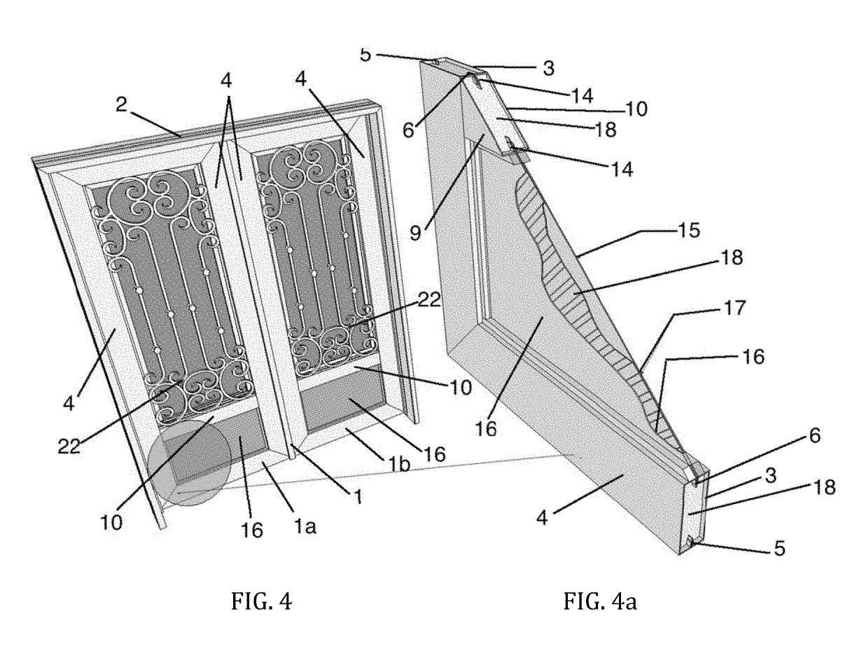

The cavities defined between the inner (3) and outer (4) metal panels bent in the shape of an idler that define the rectangular frames (3a, 4a); the cavities defined between the inner (15) and outer (16) steel plates and the cavities defined between the transversal panels (9, 10) bent in the shape of an idler are filled with expanded polyurethane (18, see FIGS. 2a and 4a) or other materials with similar isolating properties.

Such upper opening (11, see FIG. 3) is covered with translucent panels (19a, 19b) selected from panels made of glass, acrylic or other translucent materials with similar properties, arranged as two parallel panels detached from each other, an outer one (19b) and an inner one (19a), detached from each other to define an isolating cavity (20), mounted on tubular fixation moldings (21) whose hollows can be filled with expanded polyurethane or other materials with similar isolation properties and, alternatively, protecting, decorative ironwork (22) fixed on the outer face of the door (1), preferably fixed to the tubular fixation moldings (21) of the translucent panels (19a, 19b) of the upper opening (11).

As can be appreciated in FIGS. 1, 5 and 6, the door is defined by two door elements (1) formed by two folding wings (1a, 1b) with the same structure configuration.

In relation to FIGS. 1a to 2a, the metal frame (2) is defined by a hollow outer metal frame (2a) and an inner hollow metal frame (2b) fixed co-linearly, with a celeron hearth (24) provided on the adjacent faces, allowing a free reduced external area to receive fixation welding points (25) between both frames. Such hollow exterior metal frame (2a) is defined by a metal panel bent in the shape of an idler, whose face, where bends are generated, defines an opening (26) on the face to which such hollow inner metal frame (2b) is fixed to, which is defined by a rectangular tubular profile, where both inner and outer metal hollow frames (2a, 2b) are filled with expanded polyurethane (27, see FIG. 2a) or other materials with similar isolating properties.

Regarding FIG. 1a, a tubular vertical stop element (28) is fixed to the join area between such hollow outer metal frame (2a) and such hollow inner metal frame (2b) on the adjacent face where the door (1) is fixed with hinges (23, see FIG. 5) in such metal frame 2. Between such components, a gasket (29) is provided to seal the door to prevent air intake.

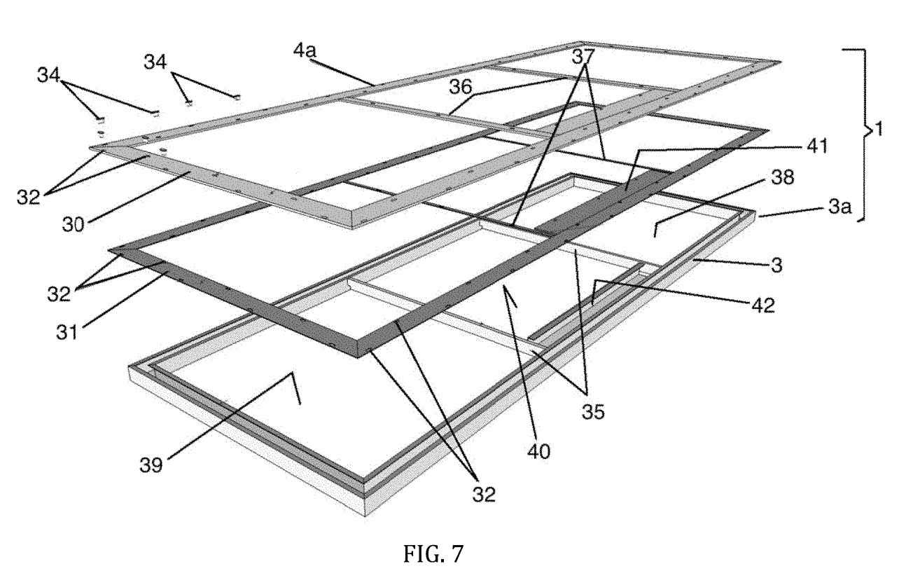

Regarding FIGS. 7 to 9, which sows one of the modalities of the invention where such door element (1) consists of an inner metal panel (3) bent in the shape of an idler, defining an inner rectangular frame (3a) and a perforated hearth outer panel (30) defining an outer rectangular frame (4a); the celeron hearth (31 also defined as a frame) provided between them as a thermal bridge break element, comprises several holes (32) distributed in a certain pattern in the same position as the perforations (33) of such perforated hearth (30) outer panel, adapted to receive the welding points (34) that will join such inner metallic panel (3) bent in the shape of an idler and such outer panel with a perforated hearth (30).

The door element (1) includes two transversal panels (35) bent in the shape of an idler, joined on the inner rectangular frame (3a), as well as two transversal panels with perforated hearths (36) fixed to the outer rectangular frame (4a), in parallel, with celeron hearths (37) with perforations that match the ones on such transversal panels with perforated hearths (36), to receive penetrating welding points (34) and defining three openings; a lower (39), upper (38) and middle (40) opening.

Where the middle opening area (40) on the inner edge of the door (1), opposed to the edge fixed to the door frame, includes a vertical panel with a perforated hearth (41) which is fixed on both transversal panels with perforated hearth (36) joined to the outer rectangular frame (4a) and a vertical frame in the shape of an idler (42), fixed to two transversal panels (35) bent in the shape of an idler foxed to the inner rectangular frame; with celeron hearths (43) with perforations that match the perforations of such vertical panel with perforated hearth (41) to receive the fixation penetrating welding points (34).

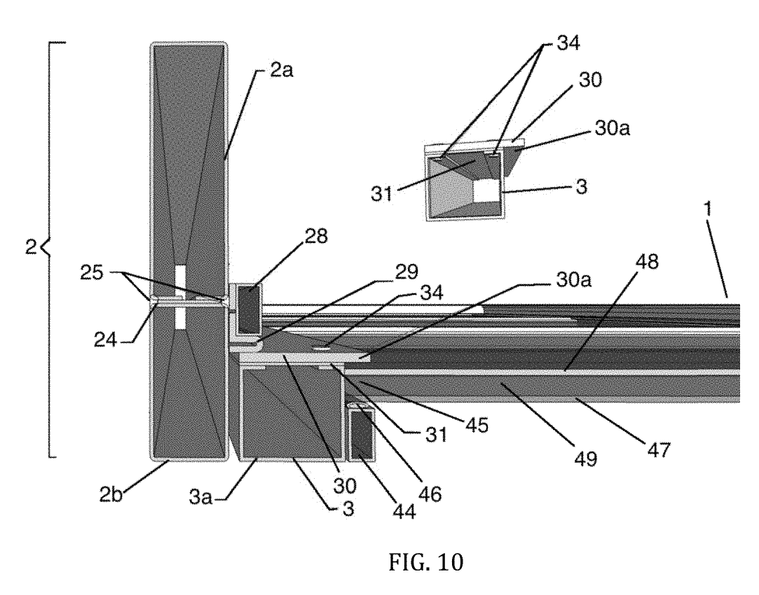

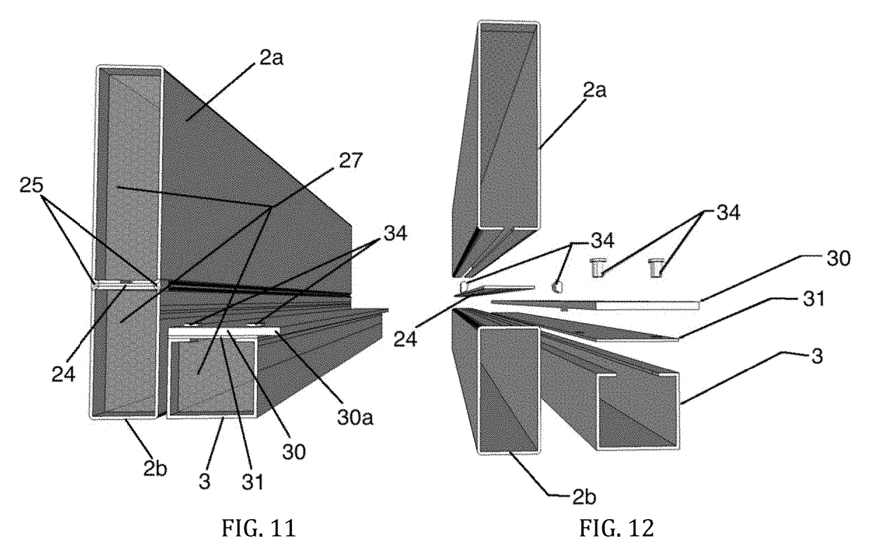

Regarding FIGS. 10 to 12, the metal frame can be seen with the configuration illustrated and described for FIG. 1, using the same reference signs. It can also be seen, as described for FIG. 7, the door element (1) defined by such metal inner panel (3) in the shape of an idler defining an inner rectangular frame (3a) and an outer frame with perforated hearth (30) defining an outer rectangular frame (4a); a celeron hearth (31 also in the shape of a frame) provided between them as a thermal bridge break element, joined by the penetrating welding points (34) joining such inner metal panel (3) bent in the shape of an idler and the outer panel with perforated hearth (30).

Specifically about FIG. 10, such outer panel with perforated hearth (30) defining an outer rectangular frame (4a) is wider that the inner metal frame (3) bent in the shape of an idler, defining an inner rectangular frame (3a), in such a way that a protruding flange (30a) is generated towards the inner face and along with a vertical tubular element (44) fixed to the inner face of the inner metal panel (3) bent in the shape of an idler, defining a perimeter channel (45) that works as fixation, along with the gasket elements (46) to receive inner (47) and outer (48) translucent panels, made of glass, acrylic or other translucent materials with similar properties or non-translucent solid panels covering such upper (38), lower (38) and middle (40) openings, arranged as two inner and outer parallel panels, detached from each other to define an isolating cavity (49).

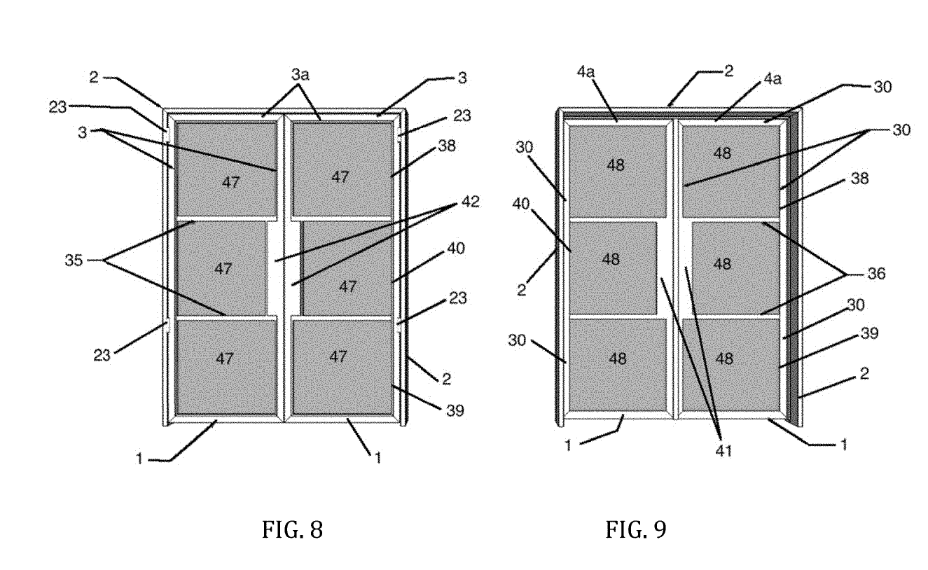

Regarding FIGS. 8 and 9, they show a door with thermal bridge break in one of the invention modalities, the doors is defined by two door elements (1) mounted on the frames (2) through hinges (23). The upper (38), middle (40) and lower (39) openings are covered by the inner (47) and outer (48) translucent panels. The same reference signs are used, which indicate the same elements already described in the section describing FIGS. 7 and 9.

The invention has been described enough for a person with medium knowledge on the field to reproduce and obtain the results mentioned in the invention herein. Nevertheless, any person with skills in the technical field related to this invention is able to make adjustments that have not been described in the request herein. Nevertheless, if the application of these adjustments in a certain system requires the matters stated in the following claims, such systems must be included within the scope of the invention.

1. A door structure with thermal bridge break defined by a door element mounted with hinges on a metal frame; characterized by such door element being fixed by hinges to such metal frame, defined by an inner metal panel bent in the shape of an idler and an outer metal panel bent in the shape of an idler or an outer panel with perforated hearths; provided with celeron hearths on the perimeter as a thermal bridge break element and defining a middle cavity filled with expanded polyurethane or other materials with similar isolating properties; and such inner and outer metal panels or the outer panel with perforated hearth are joined on the perimeter through welding points.

2. The door structure with thermal bridge break according to claim 1, characterized by including protecting and decorative ironwork fixed to the outer face of the outer metal panel of such door.

3. The door structure with thermal bridge break according to claim 1, characterized by such inner and outer metal panels bent in the shape of an idler of such door element, defining a rectangular frame, whose bends establish an outer perimeter edge and an inner perimeter edge in which the celeron hearths as thermal bridge break element are provided with notches on the outer edges, where every notch defines a space to receive welding points to join such inner and outer metal panels. At least one transversal panel bent in the shape of an idler is fixed to every rectangular frame of every inner and outer metal panel, which are in parallel, defining outer and lower openings, whose bends establish edges where celeron hearths are provided as a thermal bridge break element and fixed through welding points. An inner steel plate and an outer steel plate are fixed internally and externally to such lower opening and a celeron plate is provided between them as a thermal bridge break element. The translucent or non-translucent panels are mounted on such upper opening.

4. The door structure with thermal bridge break according to claim 3, characterized by such translucent or non-translucent panels being fixed to such upper opening of the door element in a parallel arrangement of two panels, detached from each other, one external panel and one internal panel, detached from each other to define an isolating cavity, mounted on tubular moldings and sealing gaskets whose hollows can be filled with expanded polyurethane or other materials with similar isolating properties and, alternatively, protecting and decorative ironwork fixed to the outer face of the door, preferably fixed to the fixation moldings on the translucent panels on the upper opening.

5. The door structure with thermal bridge break according to claim 3, characterized by the cavities being defined between the inner and outer metal panels bent in the shape of an idler defining the rectangular frames; as well as the cavities being defined between the inner and outer steel plates and the cavities defined between the transversal panels bent in the shape of an idler, filled with expanded polyurethane or other materials with similar isolating properties.

6. The door structure with thermal bridge break according to claim 3, characterized by such non-translucent panels which consist of an inner steel plate and an outer steel plate, fixed internally and externally to such upper opening, with a celeron plate between them as a thermal bridge break element.

7. The door structure with thermal bridge break according to claim 1, characterized such door element being formed by an inner metallic panel bent in the shape of an idler defining an inner rectangular frame and an outer panel with perforated hearth defining an outer rectangular frame; such celeron hearth provided between these as a thermal bridge break element has several holes distributed in a certain pattern, in the same position as the perforations of such perforated hearth exterior panel, adjusted to receive the penetrating welding points joining such inner metal panel bent in the shape of an idler and the outer panel with perforated hearth.

8. The door structure with thermal bridge break according to claim 7, characterized by including two transversal panels bent in the shape of an idler joined on the inner rectangular frame and two transversal panels with perforated hearths joined on the exterior rectangular frame, which are arranged in parallel, with celeron hearths provided, with perforations that match the perforations of such transversal panels with perforated hearths to receive penetrating welding points, defining three openings; upper, lower and middle openings.

9. The door structure with thermal bridge break according to claim 7, characterized by the area of the middle opening being on the inner edge of the door element, opposed to the edge fixed to the edge of the door, including a vertical panel of perforated hearth joined on both transversal panels with perforated hearth joined to the outer rectangular frame and a vertical panel in the shape of an idler joined to both transversal panels bent in the shape of an idler fixed to the inner rectangular frame; with celeron hearths between them, with perforations that match the perforations of such vertical panel with perforated hearths to receive penetrating fixation welding points.

10. The door structure with thermal bridge break according to claim 7, characterized by the internal hollows generated between such outer and inner rectangular frames of the door element, the transversal panels and the vertical panels being filled with expanded polyurethane or other materials with similar isolation properties.

11. The door structure with thermal bridge break according to claim 7, characterized by such external panel with perforated hearth defining the outer rectangular frame being wider than such inner metal frame bent in the shape of an idler, defining an inner rectangular frame, in such a way that a protruding flange is generated towards the internal face and along with a fixed vertical tubular element on the inner face of such metal inner panel bent in the shape of an idler, defining an inner rectangular frame, defining a perimeter channel that works as fixation along with the gaskets to receive translucent panels made of glass, acrylic or other translucent material with similar properties or non-translucent solid panels covering such upper, lower and middle panels, arranged as two parallel panels detached from each other, one external and one internal, detached from each other to define an isolating cavity.

12. The door structure with thermal bridge break according to claim 1, characterized by the metal frame being defined by a hollow outer metal frame and a hollow inner metal frame fixed, co-linearly, and with a celeron hearth provided between them with side notches on its adjacent faces allowing a free reduced area on every notch or perforation to receive the fixation welding points between both frames.

13. The door structure with thermal bridge break according to claim 12, characterized by such outer metal hollow frame being defined by a metallic panel bent in the shape of an idler, whose face, where bends are generated defining and opening, is the face fixed to such inner hollow metal frame, filled with expanded polyurethane or other materials with similar isolating properties.

14. The door structure with thermal bridge break according to claim 12, characterized by such inner hollow metal frame being defined by a rectangular tubular profile.

15. The door structure with thermal bridge break according to claim 12, characterized by also including a fixed tubular vertical stop element on the join area between such hollow outer metal frame and such hollow inner metal frame on the adjacent face where the door element is fixed with hinges to such metal frame and including, among those elements, a gasket to seal the door and prevent air intake.

16. The door structure with thermal bridge break according to claim 8, characterized by the internal hollows generated between such outer and inner rectangular frames of the door element, the transversal panels and the vertical panels being filled with expanded polyurethane or other materials with similar isolation properties.

17. The door structure with thermal bridge break according to claim 9, characterized by the internal hollows generated between such outer and inner rectangular frames of the door element, the transversal panels and the vertical panels being filled with expanded polyurethane or other materials with similar isolation properties.
